(19) United States
(12) Patent Application Publication
(10) Pub. No.: US 2026/0349386 A1
(43) Pub. Date: Nov. 5, 2026

(54) HOLOGRAPHIC PROJECTOR APPARATUS AND CONTROL METHOD

(71) Applicant: SONY GROUP CORPORATION, TOKYO (JP)

(72) Inventor: YOSHIAKI KOUYAMA, KANAGAWA (JP)

(21) Appl. No.: 19/486,504

(22) PCT Filed: May 21, 2024
(86) PCT No.: PCT/JP2024/018634

§ 371 Date: Nov. 21, 2025

(30) Foreign Application Priority Data
Jun. 1, 2023 (JP) 2023-090874

(51) Int. Cl. G03H 1/22; G03H 1/08; G03H 1/26

(52) U.S. Cl. CPC G03H 1/2294; G03H 1/0808; G03H 1/2645

(57) ABSTRACT

A holographic projector apparatus according to the present technology includes: a light source; a spatial light modulation unit that performs spatial light modulation on light emitted from the light source; a projection unit that projects a reproduced image generated by the spatial light modulation unit; and a control unit that calculates a correction hologram for correcting degradation of the reproduced image on the basis of a target image and degradation element information that is information indicating at least a resolution degradation element of the reproduced image generated on a projection path from the light source to the projection unit, and performs control such that the spatial light modulation unit is driven by a spatial light modulation pattern based on the correction hologram calculated.

### TECHNICAL FIELD

The present technology relates to a holographic projector apparatus that projects an image using a holography technology and a method for controlling the apparatus, and particularly relates to a technology for correcting resolution degradation of a reproduced image.

### BACKGROUND ART

A holographic projector apparatus that projects an image using a holography technology is known. By using a holography technology, it is possible to display a two-dimensional (2D) image or a three-dimensional (3D) image.

Some holographic projector apparatuses are configured to form a hologram using, for example, a spatial light modulator such as a liquid crystal panel. In this case, the hologram to be formed can be changed by changing the spatial light modulation pattern in the spatial light modulator, and the display image can be changed. That is, by changing the spatial light modulation pattern in the spatial light modulator, it is possible to switch a still image to be displayed or display a moving image.

Note that Patent Document 1 below can be cited as related conventional techniques. Patent Document 1 below discloses a technique for enhancing resolution of a hologram image at a user's gaze point.

### CITATION LIST

### Patent Document

Patent Document 1: Japanese Patent Application Laid-Open No. 10-326071

### SUMMARY OF THE INVENTION

### Problems to be Solved by the Invention

Here, in a holographic projector apparatus, resolution degradation of a reproduced image may occur in a projection path for projecting the reproduced image.

However, in a conventional holographic projector apparatus, a technique for correcting resolution degradation occurring in such a projection path has not been established. For example, it is conceivable to use a high-resolution spatial light modulator in anticipation of occurrence of resolution degradation, but in this case, the spatial light modulator to be used becomes expensive, and it becomes difficult to achieve cost reduction.

The present technology has been made in view of the above circumstances, and an object of the present technology is to suppress resolution degradation while reducing the price of a holographic projector apparatus.

### Solutions to Problems

A holographic projector apparatus according to the present technology includes: a light source; a spatial light modulation unit that performs spatial light modulation on light emitted from the light source; a projection unit that projects a reproduced image generated by the spatial light modulation unit; and a control unit that calculates a correction hologram for correcting degradation of the reproduced image on the basis of a target image and degradation element information that is information indicating at least a resolution degradation element of the reproduced image generated on a projection path from the light source to the projection unit, and performs control such that the spatial light modulation unit is driven by a spatial light modulation pattern based on the correction hologram calculated.

According to the above configuration, it is possible to perform resolution degradation correction in consideration of the resolution degradation element actually occurring in the projection path, and it is possible to realize appropriate resolution degradation correction. In addition, by performing resolution degradation correction, a low-resolution spatial light modulator can be used.

### BRIEF DESCRIPTION OF DRAWINGS

FIG. 1 is a diagram illustrating a configuration example of a holographic projector apparatus as a first embodiment according to the present technology.

FIG. 2 is an explanatory diagram illustrating a principle of forming a hologram by spatial light phase modulation.

FIG. 3 is an explanatory diagram of a disclination countermeasure.

FIG. 4 is an explanatory diagram of various functions for realizing a degradation correction method as the first embodiment.

FIG. 5 is an explanatory diagram of an example of shift multiplexing display.

FIG. 6 is a flowchart illustrating an example of a specific processing procedure to be executed to implement a degradation correction method as the first embodiment.

FIG. 7 is a diagram illustrating a configuration example of a holographic projector apparatus as a second embodiment.

FIG. 8 is an explanatory diagram illustrating a principle of forming a hologram by spatial light amplitude modulation.

FIG. 9 is a diagram illustrating a configuration example of a holographic projector apparatus as a third embodiment.

FIG. 10 is an explanatory diagram of degradation correction method as the third embodiment.

FIG. 11 is an explanatory diagram of various functions for realizing a degradation correction method as the third embodiment.

FIG. 12 is a flowchart illustrating an example of a specific processing procedure to be executed to implement a degradation correction method as the third embodiment.

FIG. 13 is an explanatory view of a problem in a case where the reproduction surface has irregularities.

FIG. 14 is an explanatory diagram in a case where calculation of a correction hologram is performed assuming a reproduction surface having irregularities.

FIG. 15 is an explanatory view of a holographic projector apparatus as a modification.

### MODE FOR CARRYING OUT THE INVENTION

Hereinafter, embodiments according to the present technology will be described in the following order with reference to the accompanying drawings.
<1. First Embodiment>
[1-1. Apparatus Configuration Example]
[1-2. Degradation Correction Method as First Embodiment]
[1-3. Processing Procedure]
<2. Second Embodiment>
<3. Third Embodiment>
<4. Modifications>
<5. Summary of Embodiments>
<6. Present Technology>

### 1. First Embodiment

### 1-1. Apparatus Configuration Example

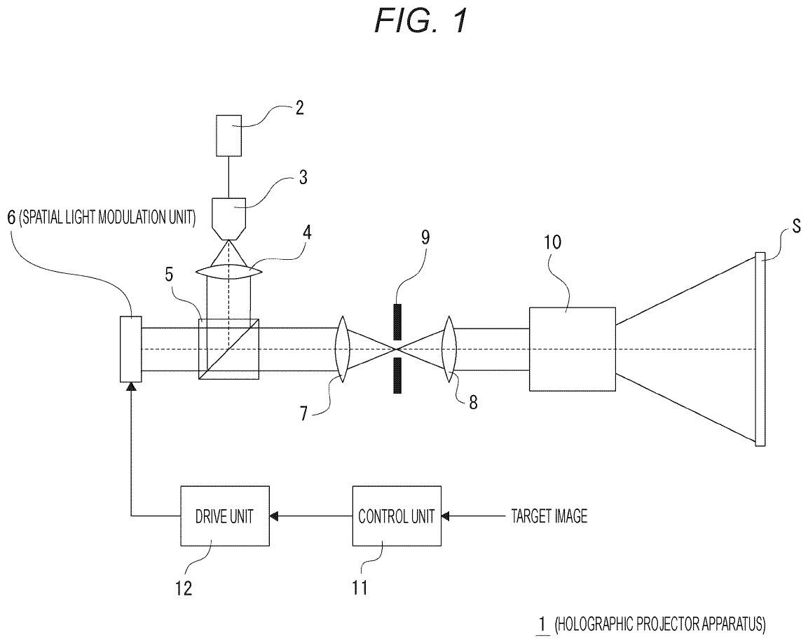

FIG. 1 is a diagram illustrating a configuration example of a holographic projector apparatus 1 as a first embodiment according to the present technology.

Here, as an example, a holographic projector apparatus that displays a 2D (two-dimensional) image is illustrated.

As illustrated in the drawing, the holographic projector apparatus 1 includes a light source 2, a beam expander 3, a collimator lens 4, a beam splitter 5, a spatial light modulation unit 6, a relay lens 7, a relay lens 8, an optical filter 9, a projection lens 10, a control unit 11, and a drive unit 12.

The light source 2 is provided as a light source for generating a reproduced image. In the holographic projector apparatus, a coherent light source is desirably used as the light source of the reproduced image, and in the present example, a semiconductor laser is used as the light source 2.

The light emitted from the light source 2 is converted into diffused light by the beam expander 3, converted into parallel light by the collimator lens 4, and incident on the beam splitter 5.

The light incident on the beam splitter 5 from the light source 2 side in this manner is reflected by the selective reflection surface of the beam splitter 5, and is incident on the spatial light modulation unit 6 as illustrated in the drawing.

The spatial light modulation unit 6 includes a spatial light modulator, and performs spatial light modulation on incident light by the spatial light modulator. This spatial light modulation is spatial light modulation for holographic projection, and a reproduced image for realizing image display is generated by the spatial light modulation.

In the present embodiment, as the spatial light modulator in the spatial light modulation unit 6, a spatial light phase modulator (hereinafter, sometimes abbreviated as a “phase modulator”) that performs spatial light phase modulation on incident light is used. Specifically, a liquid crystal panel is used as the phase modulator. The liquid crystal panel is configured by two-dimensionally arraying a plurality of pixels capable of adjusting an alignment state of liquid crystal, and spatial light phase modulation to incident light can be independently performed for each pixel. In the present example, for example, liquid crystal on silicon (LCOS) is used as the liquid crystal panel.

In the present example, the spatial light modulation unit 6 includes a reflective spatial light modulator as the spatial light modulator. Therefore, the light subjected to the spatial light modulation (spatial light phase modulation in the present example) by the spatial light modulation unit 6 is emitted from the spatial light modulation unit 6 as reflected light from the reflective spatial light modulator (reflective liquid crystal panel in the present example).

The light emitted from the spatial light modulation unit 6 as the light after the spatial light modulation is incident on the selective reflection surface of the beam splitter 5 again, passes through the selective reflection surface, and is incident on the relay lens system including the relay lens 7 and the relay lens 8.

Note that, by using, for example, a polarizing beam splitter as the beam splitter 5, it is possible to reduce a loss of light related to reflection of incident light from the light source 2 side and transmission of incident light from the spatial light modulation unit 6, and it is possible to enhance utilization efficiency of light.

As illustrated in the drawing, the light incident on the relay lens 7 is converted from parallel light to convergent light, focused at a predetermined position, and then incident on the relay lens 8 in a state of diffused light. The relay lens 8 converts the incident diffused light into parallel light and emits the parallel light to the projection lens 10.

The optical filter 9 is disposed between the relay lenses 7 and 8. The optical filter 9 transmits the first-order diffracted light and shields other light (0th-order diffracted light, high-order diffracted light, or the like) at a position where the light emitted from the relay lens 7 is focused. As a result, noise light is removed.

The projection lens 10 enlarges and projects a reproduced image incident through the relay lens 8 onto a projection target such as the screen S.

Consequently, the 2D image can be displayed on the projection target such as screen S.

The control unit 11 is configured as a computer apparatus including a microcomputer including, for example, a central processing unit (CPU), a read only memory (ROM), a random access memory (RAM), and the like, and executes various processes related to image display in the holographic projector apparatus 1.

The drive unit 12 includes a drive circuit for driving a spatial light modulator (a phase modulator in the present example) included in the spatial light modulation unit 6. The drive unit 12 is configured to be able to individually drive each pixel of the spatial light modulator included in the spatial light modulation unit 6.

As illustrated in the drawing, a target image (a 2D image in the present example) that is a display target image is input to the control unit 11. The control unit 11 controls the drive unit 12 on the basis of the target image to cause the spatial light modulation unit 6 to execute spatial light modulation for image display.

Specifically, the control unit 11 calculates a hologram (CGH: Computer Generated Hologram) for obtaining a reproduced image corresponding to the target image on the basis of the target image. Then, a spatial light modulation pattern of the spatial light modulation unit 6 for forming the calculated hologram by spatial light modulation by the spatial light modulation unit 6 is calculated, and the drive unit 12 is controlled so that spatial light modulation according to the spatial light modulation pattern is performed.

Here, the “° spatial light modulation pattern” means information indicating a light modulation mode of each pixel of the spatial light modulation unit 6 (spatial light modulator). Specifically, in the present example, it is information indicating a drive signal value for each pixel of the spatial light modulation unit 6.

As described above, the control unit 11 controls the spatial light modulation pattern of the spatial light modulation unit 6 on the basis of the target image, thereby realizing display of a 2D image reproducing the target image.

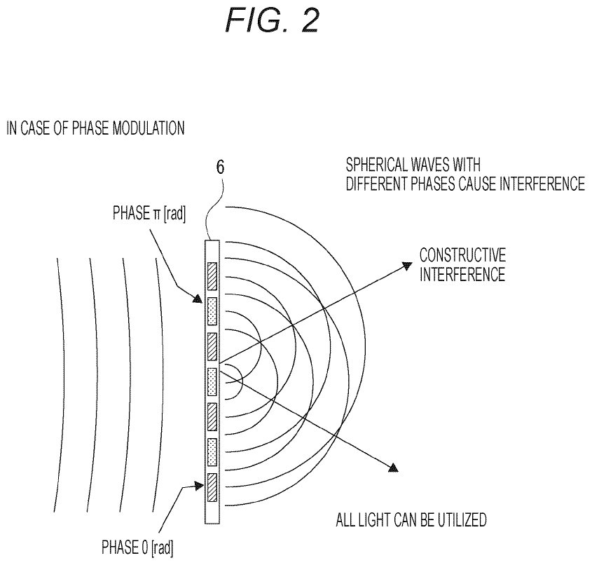

A principle of forming a hologram by spatial light phase modulation will be described with reference to FIG. 2. Here, for the sake of description, a case where a transmissive modulator is used as the phase modulator in the spatial light modulation unit 6 is illustrated, but it similarly applies in principle to a case where a reflective modulator is used.

In the drawing, an example is illustrated in which there are a pixel that modulates the phase of the incident light to the phase 0 [rad] and a pixel that modulates the phase to the phase n [rad] in the spatial light modulation unit 6. By performing the spatial light phase modulation that imparts the phase distribution to the incident light in this manner, spherical waves of different phases cause interference, and intensification of light due to the interference occurs in a certain pattern. That is, an interference fringe (hologram) by a certain pattern is formed. At this time, the pattern of the hologram can be controlled by the pattern of the phase distribution given to the incident light in the phase modulator, that is, the spatial light modulation pattern of the phase modulator.

### 1-2. Degradation Correction Method as First Embodiment

Here, in the holographic projector apparatus, it has been confirmed that the resolution of the reproduced image is degraded in the projection path for projecting the reproduced image. In particular, in a case where the noise light removal is performed using the optical filter 9 as in the holographic projector apparatus 1 described above, the resolution of the reproduced image is easily degraded. Specifically, in a case where the noise light removal is performed in the real space, since a method of separating the noise light while narrowing the region of the original reproduced image is adopted, the image is displayed with a resolution lower than the resolution that can be originally displayed, and the resolution is degraded. Furthermore, in a case where the filter is used in the spatial frequency domain, the angular resolution contributing to the reproduced image is limited, and thus the resolution of the reproduced image is degraded due to this point.

In addition, in a case where a liquid crystal panel is used as the spatial light modulator, resolution degradation of the reproduced image occurs due to taking a measure against the disclination of the liquid crystal panel.

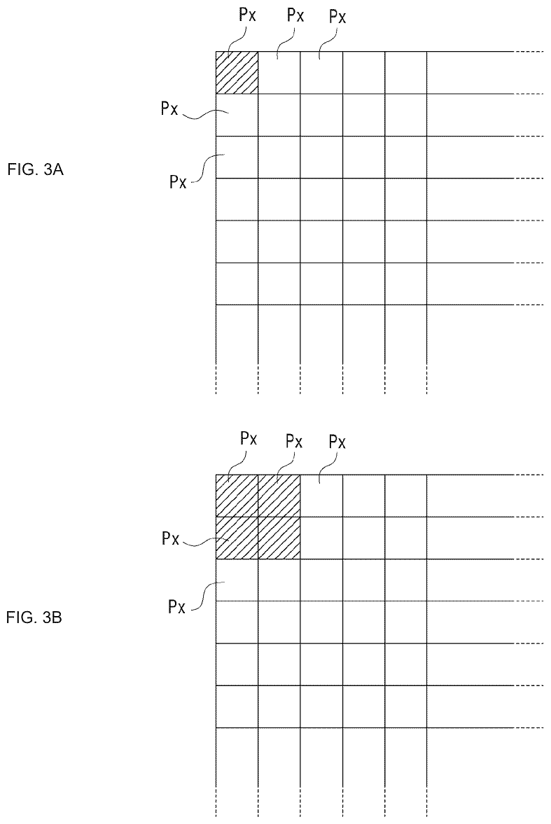

Specifically, in a case where a liquid crystal panel is used as the spatial light modulator, a spatial light modulator having a large pixel pitch is used in order to suppress the degradation of the display image quality due to the disclination, or the same information is written in a plurality of adjacent pixels (2×2=4 pixels or more) to increase the pixel pitch in a pseudo manner as illustrated in FIG. 3B although information should be originally written independently in units of pixels (indicated as “Px” in the drawing) as in FIG. 3A.

In a case where the pixel pitch is actually increased as in the former case, since the panel size is increased, the number of pixels obtained per production sheet is reduced, and there is also a problem that the cost is increased. Therefore, it is difficult to increase the panel size, and as a result, the number of pixels of the liquid crystal panel is reduced, and the resolution of the reproduced image is degraded.

In addition, in a case where the pixel pitch is increased in a pseudo manner as in the latter case, the effective number of pixels decreases, which causes resolution degradation of the reproduced image.

Therefore, in the present embodiment, a method is adopted in which degradation correction of a reproduced image is performed using degradation element information that is information indicating at least a resolution degradation element of the reproduced image generated on a projection path from the light source 2 to a projection unit (at least a portion including the projection lens 10).

In the present embodiment, the processing for the degradation correction is executed by the control unit 11.

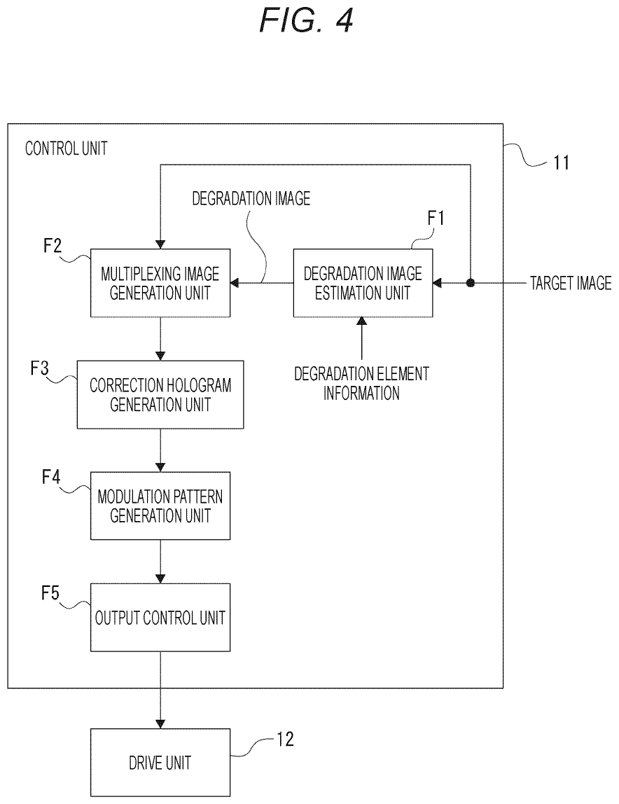

With reference to FIG. 4, various functions of the control unit 11 for realizing the degradation correction method as the first embodiment will be described.

Note that FIG. 4 illustrates the drive unit 12 illustrated in FIG. 1 together with the functional blocks included in the control unit 11.

In the present embodiment, the control unit 11 calculates a correction hologram for correcting the degradation of the reproduced image on the basis of the target image and the above-described degradation element information, and performs control so that the spatial light modulation unit 6 is driven by the spatial light modulation pattern based on the calculated correction hologram.

For this reason, the control unit 11 in the present embodiment has functions as a degradation image estimation unit F1, a multiplexing image generation unit F2, a correction hologram generation unit F3, a modulation pattern generation unit F4, and an output control unit F5 illustrated in the drawing.

Here, in the present embodiment, a method of shift multiplexing and displaying a plurality of reproduced images is adopted in order to correct degradation of resolution.

Here, the shift multiplexing display referred to in the present specification is a display method of overlapping a plurality of reproduced images on the reproduction surface, and means a display method involving a shift of a display position less than a pixel pitch between the reproduced images.

By performing such shift multiplexing display, it is possible to realize high-resolution image display using a reproduced image with low resolution. That is, resolution degradation correction based on a so-called super-resolution technique can be realized.

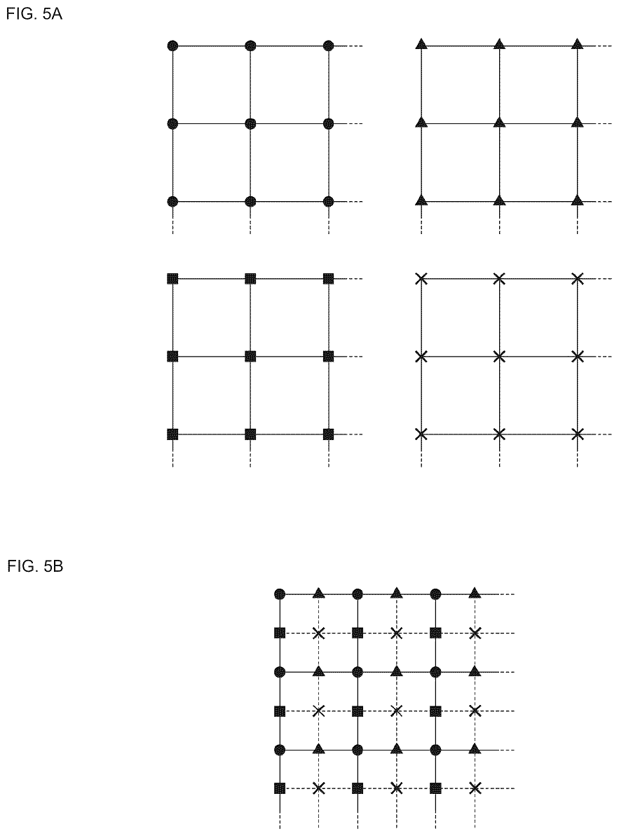

An example of shift multiplexing display in the present example will be described with reference to FIG. 5.

FIG. 5A schematically illustrates a plurality of reproduced images used for resolution degradation correction. As illustrated in FIG. 5A, in the present example, four reproduced images are generated as reproduced images used for resolution degradation correction.

Then, as illustrated in FIG. 5B, these four reproduced images are superimposed on the reproduction surface, and at this time, a shift less than the pixel pitch occurs in the image forming region between the reproduced images. Specifically, in the present example, a shift for half a pixel is caused. As illustrated in the drawing, based on the image forming region of one reproduced image among the four reproduced images, the remaining one reproduced image is shifted by a half pixel (see reproduced image of ▴ in the drawing) in the lateral direction (horizontal direction), the remaining another reproduced image is shifted by a half pixel (see reproduced image of ▪ in the drawing) in the vertical direction (vertical direction), and the remaining still another reproduced image is shifted by a half pixel (see reproduced image of x in the drawing) in the oblique direction, so that a shift by a half pixel occurs in the image forming region between the respective reproduced images.

In the present embodiment, the shift multiplexing display is performed by projecting the above-described four reproduced images in a time division manner. Specifically, the control unit 11 in the present embodiment calculates a plurality of correction holograms for shift multiplexing display, and controls the spatial light modulation unit 6 so that the correction holograms are formed in a time division manner.

By forming a plurality of correction holograms for shift multiplexing display in a time division manner in this manner, it is possible to realize a shift of a reproduced image for shift multiplexing display by the correction holograms.

Since the shift of the reproduced image is realized by the time-division formation of the correction hologram, it is not necessary to provide a shift device for shifting the position of the reproduced image on the reproduction surface in order to realize the shift multiplexing display.

Note that, for confirmation, in order to make the formation regions of the respective reproduced images different on the reproduction surface as illustrated in FIG. 5B, it is sufficient to make the setting of which region on the reproduction surface is set as the formation target region of the reproduced image different in the calculation of each correction hologram.

In FIG. 4, the function from the degradation image estimation unit F1 to the correction hologram generation unit F3 is a function of generating a plurality of correction holograms for realizing resolution degradation correction by shift multiplexing display as described above.

On the basis of the target image and the degradation element information, the degradation image estimation unit F1 estimates a degradation image as an image in which degradation indicated by the degradation element information is given to the target image.

As a specific procedure, first, a hologram that reproduces a target image is calculated as a pre-degradation hologram, then a degradation hologram is calculated on the basis of the pre-degradation hologram and degradation element information, and then a reproduced image by the degradation hologram is calculated as a degradation image.

The pre-degradation hologram can be obtained by, for example, wavefront propagation calculation by an angular spectrum method. Specifically, it can be calculated as “Hologram” illustrated in the following [Formula 1].

$$\begin{matrix}[ Math . 1 ] & \\ Hologram = {ℱ}^{- 1} [ ℱ [ {u}_{1} ( x , y ) ] exp ( i 2 π z \sqrt{\frac{1}{{λ}^{2}} - {f}_{x}^{2} - {f}_{y}^{2}} ) ] & [ Formula 1 ]\end{matrix}$$

In [Formula 1], “F” represents a Fourier transform, “F⁻¹” represents an inverse Fourier transform, “fₓ” and “f_{y}” represent coordinates in a frequency domain, “u₁” represents a target wavefront, and “λ” represents a wavelength of light.

In the present embodiment, as the degradation correction of the reproduced image, the resolution degradation by the optical filter 9 and the degradation occurring in the liquid crystal panel of the spatial light modulation unit 6, specifically, the degradation of the reproduced image due to the disclination described above are corrected. Furthermore, in the present example, the degradation caused by the optical aberration occurring in the reproduced image is also corrected. Examples of the optical aberration here include lens distortion occurring in the projection lens 10.

In the present example, as the degradation image, an image in which the resolution degradation due to the optical filter 9, the degradation of the reproduced image due to the disclination, and the degradation of the reproduced image due to the optical aberration are reproduced is generated. Therefore, as the above-described degradation element information, information on the resolution degradation element by the optical filter 9, information on the degradation element of the reproduced image due to the disclination, and information on the degradation element of the reproduced image due to the optical aberration are prepared.

Note that it is conceivable that information indicating various degradation elements is obtained experimentally or by simulation calculation in advance.

First, a degradation hologram is calculated on the basis of a pre-degradation hologram and degradation element information.

In the present example, the calculation of the degradation hologram is performed so as to impart the degradation due to the degradation element to the pre-degradation hologram using the information on the resolution degradation element by the optical filter 9, the information on the degradation element of the reproduced image due to the disclination, and the information on the degradation element of the reproduced image due to the optical aberration, which are prepared in advance as the degradation element information.

Specifically, the calculation of imparting degradation due to disclination can be performed as a calculation for obtaining “Hologram_Dl” in the following [Formula 2].

[Math. 2]

Hologram_Dl=A*exp( [symbol] [ [symbol] [φ] [symbol] [d]]) [Formula 2]

In [Formula 2], “A” and “cp” mean an amplitude hologram and a phase hologram in a pre-degradation hologram as a complex amplitude hologram obtained by calculation of [Formula 1]. In addition, “d” means a band limitation of the display pattern received by the disclination. The information of “d” corresponds to the information of the degradation element of the reproduced image due to the disclination.

In addition, the calculation for giving resolution degradation by the optical filter 9 can be performed as calculation for obtaining “Hologram_Df” in the following [Formula 3].

[Math. 3]

Hologram_Df= [symbol] [Mask* [symbol] [Ae^{iφ}]] [Formula 3]

In [Formula 3], “Mask” represents the band limitation of the hologram in the frequency space. Note that, as for “A” and “φ” in [Formula 3], an amplitude hologram and a phase hologram in a complex amplitude hologram obtained as “Hologram_Dl” by [Formula 2] are used.

The information of “Mask” in [Formula 3] corresponds to the information of the resolution degradation element by the optical filter 9.

Furthermore, in the present example, calculation of further imparting degradation of a reproduced image due to optical aberration to the complex amplitude hologram as “Hologram_Df” obtained in [Formula 3] is performed. This calculation can be performed in a similar manner to [Formula 2] and [Formula 3] by using information on the degradation element of the reproduced image due to the optical aberration prepared in advance, such as information indicating the degradation element as the lens distortion occurring in the projection lens 10.

In the present example, a hologram obtained by imparting various types of degradation indicated by the degradation element information to the pre-degradation hologram as described above is calculated as a degradation hologram.

The degradation image estimation unit F1 calculates a reproduced image by the degradation hologram as a degradation image. The degradation image can be obtained by performing wavefront propagation calculation in the same manner as in [Formula 1] for the degradation hologram.

Note that, regarding the degradation of resolution due to the optical filter 9, the degradation of the reproduced image due to the disclination, and the degradation of the reproduced image due to the optical aberration, the order of applying the degradation is not limited to the above order, and for example, another order such as the degradation application of the reproduced image due to the optical aberration→the resolution degradation application by the optical filter 9→the degradation application of the reproduced image due to the disclination can be adopted.

Here, the degradation element information, specifically, the information on the resolution degradation element by the optical filter 9 in the present example, the information on the degradation element of the reproduced image due to the disclination, and the information on the degradation element of the reproduced image due to the optical aberration are stored in a memory (nonvolatile memory) readable by the control unit 11. It is conceivable that the memory is provided in the holographic projector apparatus 1. Alternatively, the memory may be provided in an external apparatus (for example, a cloud server or the like).

On the basis of the difference between the degradation image and the target image obtained by the degradation image estimation unit F1, the multiplexing image generation unit F2 generates, by calculation, a plurality of (four in the present example) multiplexing images to be used for the above-described shift multiplexing display.

Specifically, four images (the resolution is the same as the resolution of the target image) in which the difference between the degradation image and the target image can be canceled by performing the shift multiplexing display described with reference to FIG. 5 are obtained as multiplexing images by calculation.

Note that, as a method of calculating a plurality of multiplexing images used for shift multiplexing display for resolution degradation correction on the basis of the difference between the degradation image and the target image, a calculation method used in a general super-resolution technique can be used. As an example, for example, it is conceivable to use the method disclosed in Reference Document 1 below.
Reference Document 1: “Image Enhancement in Projectors via Optical Pixel Shift and Overlay” Behzad Sajadi, Duy Qoc-Lai, Alex T. Ihler, M. Gopi, Aditi Majumder: Department of Computer Science University of California, Irvine

For each multiplexing image calculated by the multiplexing image generation unit F2, the correction hologram generation unit F3 generates a hologram for obtaining the multiplexing image as a reproduced image by calculation as a correction hologram.

The conversion from the multiplexing image to the correction hologram can also be performed by wavefront propagation calculation as illustrated in [Formula 1] above, similarly to the conversion from the target image to the pre-degradation hologram described above.

For each correction hologram obtained by the correction hologram generation unit F3, the modulation pattern generation unit F4 generates the spatial light modulation pattern of the spatial light modulation unit 6 for forming the correction hologram by calculation.

Here, in the present embodiment, since the spatial light phase modulation is performed as the spatial light modulation, only the phase hologram is extracted for the correction hologram as the complex amplitude hologram.

Specifically, assuming that the correction hologram is obtained as “u₂(x′, y′)” illustrated in the following [Formula 4], “e^{iφ(x′, y′)}” in the [Formula 4] is extracted to obtain phase distribution information on the phase modulation surface of the spatial light modulation unit 6.

[Math. 4]

u₂(x′,y′)=a₂(x′,y′)e^{iφ2(x′,y′)} [Formula 4]

After obtaining the phase distribution information as described above for each correction hologram, the modulation pattern generation unit F4 calculates, for each correction hologram, a drive signal value for each pixel of the phase modulator for realizing the phase distribution indicated by the phase distribution information on the phase modulation surface. The drive signal value for each pixel of the phase modulator calculated for each correction hologram in this manner is information on the spatial light modulation pattern for each correction hologram.

The output control unit F5 outputs the information of the spatial light modulation pattern for each correction hologram generated by the modulation pattern generation unit F4 to the drive unit 12 in a time division manner.

As a result, the phase modulator of the spatial light modulation unit 6 is driven so as to form four correction holograms for shift multiplexing display in a time division manner. As a result, the respective reproduced images corresponding to the four multiplexing images for correcting various types of degradation such as resolution are shifted and multiplexed and displayed in a time division manner, and various types of degradation correction of the display image are realized.

For confirmation, in a case where shift multiplexing display is performed in a time division manner as in the present embodiment, the display cycle of the multiplexing image is determined to be a sufficiently fast cycle in consideration of the visual integration effect.

Here, in the present embodiment, the phase modulator is used as the spatial light modulator for the holographic projection, but this can improve the utilization efficiency of light at the time of image display. As described above with reference to FIG. 2, in the case of using the phase modulator, formation of the hologram can be realized by adjusting the phase of the incident light, so that it is not necessary to shield the incident light, and the utilization efficiency of light can be improved.

By improving the light use efficiency, it is possible to increase the contrast of the display image and reduce the power consumption of the light source 2.

Furthermore, in the present embodiment, since pixel position shift in shift multiplexing display is performed by spatial light modulation, it is not necessary to provide a shift device (for example, a device or the like that vibrates the spatial light modulator) for pixel position shift.

In a case where a shift device is used, a transition period until the pixel position is completely shifted occurs, and image display cannot be performed during the transition period, resulting in low efficiency. In a case where pixel position shift is realized by spatial light modulation as in the present embodiment, such a transition period does not occur, so that efficiency is improved.

In addition, when the shift device is unnecessary, the width of the pixel position shift does not depend on the shift device, and the display density can be improved. Therefore, it is possible to realize highly accurate resolution degradation correction such as ¼ pixel shift.

In addition, in the present embodiment, the degradation caused by the disclination of the liquid crystal panel is also corrected, but this makes it possible to eliminate the need to use a liquid crystal panel having a large pixel pitch as a measure against the disclination or use a liquid crystal panel having four or more times the number of pixels of the reproduced image.

Therefore, downsizing and cost reduction of the holographic projector apparatus 1 can be achieved.

Furthermore, in the present embodiment, the degradation caused by the optical aberration such as the lens distortion is also corrected, but this eliminates the need to use an expensive lens having an aberration correction function, and the cost of the holographic projector apparatus 1 can be reduced.

### [1-3. Processing Procedure]

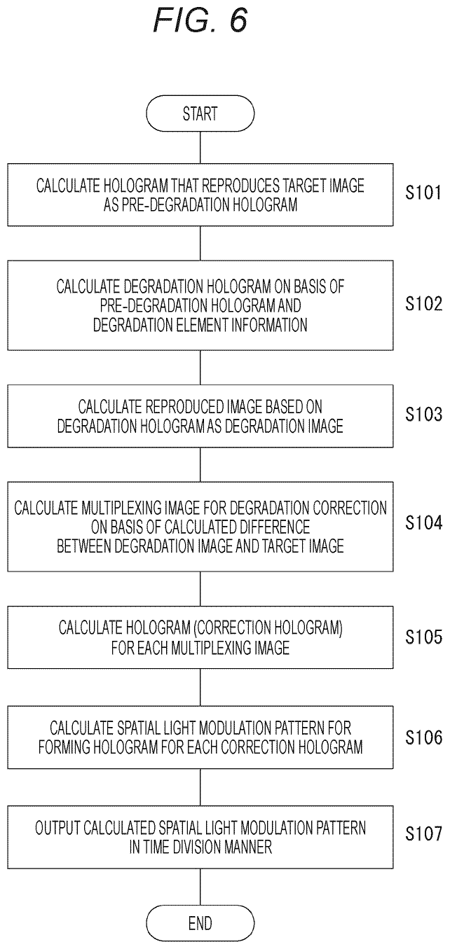

FIG. 6 is a flowchart illustrating an example of a specific processing procedure to be executed by the control unit 11 in order to realize the degradation correction method as the first embodiment described above.

Note that, in the case of displaying a moving image, the control unit 11 executes the processing illustrated in FIG. 6 for each frame image with the frame image constituting the moving image as a target image. In the case of displaying a still image, it is sufficient that the control unit 11 repeatedly executes the processing illustrated in FIG. 6 for the common target image.

First, in step S101, the control unit 11 calculates a hologram that reproduces the target image as a pre-degradation hologram. That is, the pre-degradation hologram is calculated by the above [Formula 1] on the basis of the target image.

In step S102 following step S101, the control unit 11 calculates a degradation hologram on the basis of the pre-degradation hologram and the degradation element information. Specifically, in the present example, on the basis of the information on the resolution degradation element by the optical filter 9 (“Mask” described above) stored in the memory as the degradation element information, the information on the degradation element of the reproduced image due to the disclination (“d” described above), and the information on the degradation element of the reproduced image due to the optical aberration, the processing of imparting the resolution degradation by the optical filter 9, the degradation of the reproduced image due to the disclination, and the degradation of the reproduced image due to the optical aberration to the pre-degradation hologram is performed to calculate the degradation hologram.

Note that a specific calculation method for imparting degradation has already been described, and thus redundant description is avoided.

In step S103 following step S102, the control unit 11 calculates a reproduced image by the degradation hologram as a degradation image. That is, as described above, the degradation image is calculated from the degradation hologram by the wavefront propagation calculation.

In step S104 subsequent to step S103, the control unit 11 calculates a multiplexing image for degradation correction on the basis of a difference between the calculated degradation image and the target image, and further calculates a hologram (correction hologram) for each multiplexing image in subsequent step S105. Since the method of calculating a multiplexing image and the method of calculating a hologram for correction have already been described, redundant description is avoided.

In step S106 following step S105, the control unit 11 calculates a spatial light modulation pattern for hologram formation for each correction hologram. That is, as described above, the phase hologram is extracted for each correction hologram to obtain the information of the phase distribution on the phase modulation surface, and then the drive signal value for each pixel of the phase modulator for realizing the phase distribution is calculated as the spatial light modulation pattern.

In step S107 following step S106, the control unit 11 outputs the calculated spatial light modulation pattern in a time division manner. That is, information of the calculated spatial light modulation pattern for each correction hologram is output to the drive unit 12 in a time division manner.

The control unit 11 terminates the series of processes illustrated in FIG. 6 in response to the execution of the process of step S107.

### 2. Second Embodiment

Next, a second embodiment will be described.

In the second embodiment, a hologram for image display is formed not by spatial light phase modulation but by spatial light amplitude modulation.

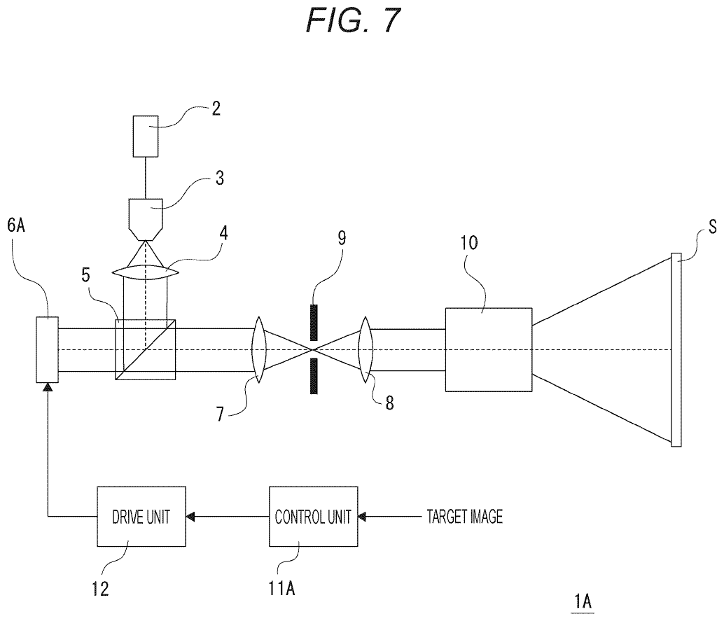

FIG. 7 is a diagram illustrating a configuration example of a holographic projector apparatus 1A as the second embodiment.

Note that, in the following description, the same reference numerals are given to portions similar to those already described, and description thereof is omitted.

The holographic projector apparatus 1A is different from the holographic projector apparatus 1 as the first embodiment in that a spatial light modulation unit 6A is provided instead of the spatial light modulation unit 6 and a control unit 11A is provided instead of the control unit 11.

The spatial light modulation unit 6A includes a spatial light amplitude modulator (hereinafter, also abbreviated as an “amplitude modulator”) as a spatial light modulator.

In the present example, a reflective liquid crystal panel is used as the amplitude modulator. The liquid crystal panel in this case is configured to be able to adjust the amplitude of the incident light for each pixel. Specifically, the light shielding degree of the incident light can be adjusted for each pixel.

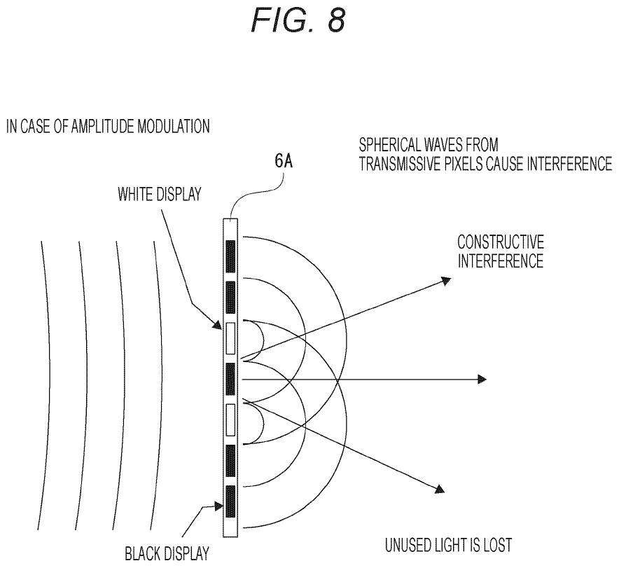

A principle of forming a hologram by spatial light amplitude modulation will be described with reference to FIG. 8. Here, for the sake of description, a case where a transmissive modulator is used as the amplitude modulator in the spatial light modulation unit 6A is illustrated, but the same applies in principle to a case where a reflective modulator is used.

In the drawing, an example is illustrated in which a pixel of white display (the lowest light shielding degree) and a pixel of black display (the highest light shielding degree) exist in the spatial light modulation unit 6A, but by performing such spatial light amplitude modulation, spherical waves from a pixel (white pixel) through which light is transmitted without being shielded cause interference, intensification of light due to the interference occurs in a certain pattern, and interference fringes (holograms) according to a required pattern are formed. At this time, the pattern of the hologram can be controlled by the pattern of the amplitude distribution applied to the incident light in the amplitude modulator, that is, the spatial light modulation pattern of the amplitude modulator.

The control unit 11A has functions similar to those of the degradation image estimation unit F1, the multiplexing image generation unit F2, the correction hologram generation unit F3, the modulation pattern generation unit F4, and the output control unit F5 included in the control unit 11, but is different from the control unit 11 in that the modulation pattern generation unit F4 performs conversion processing corresponding to the case of using an amplitude modulator for conversion from a correction hologram to a spatial light modulation pattern.

Specifically, for the correction hologram as the complex amplitude hologram obtained in the form illustrated in [Formula 4] above, “a₂(x′, y′)” which is an amplitude hologram is extracted to obtain amplitude distribution information on the amplitude modulation surface of the spatial light modulation unit 6A. The modulation pattern generation unit F4 in this case obtains the amplitude distribution information as described above for each correction hologram, and then calculates, for each correction hologram, a drive signal value for each pixel of the amplitude modulator for realizing the amplitude distribution indicated by the amplitude distribution information on the amplitude modulation surface. As a result, information of the spatial light modulation pattern for each correction hologram corresponding to the case of using the amplitude modulator is obtained.

In addition, in the second embodiment, in the case of correcting the degradation caused by the disclination of the liquid crystal panel, in the degradation image estimation unit F1, as the degradation application to the pre-degradation hologram, the degradation application according to the following [Formula 5] is performed instead of the above-described [Formula 2].

[Math. 5]

Hologram_Dl′=exp( [symbol] [ [symbol] [A] [symbol] ]]) [Formula 5]

By adopting a method of forming a hologram by spatial light amplitude modulation as in the second embodiment, an amplitude modulation type spatial light modulator generally used for image display can be used as the spatial light modulator.

### 3. Third Embodiment

In a third embodiment, the degradation correction of the reproduced image is performed only on a partial image region such as a region of interest as an image region that the user pays attention to.

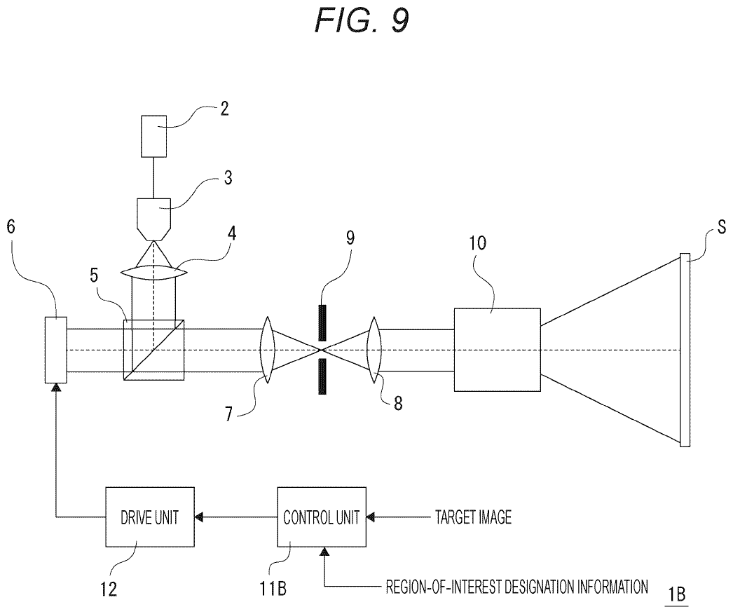

FIG. 9 is a diagram illustrating a configuration example of a holographic projector apparatus 1B as the third embodiment.

A difference from the holographic projector apparatus 1 illustrated in FIG. 1 is that a control unit 11B is provided instead of the control unit 11.

The control unit 11B controls the spatial light modulation unit so that the correction hologram is formed only for a designated part of the image region in the reproduced image.

Specifically, in the present example, the region-of-interest designation information is input to the control unit 11B. The region-of-interest designation information is information for designating a region of interest of the user, that is, an image region that the user pays attention to in the display image.

Here, it is conceivable to estimate the line-of-sight direction, the face direction, and the like of the user on the basis of a captured image obtained by imaging the user with a camera provided inside or outside the holographic projector apparatus 1B, and to specify the region of interest on the basis of the result. Alternatively, the region of interest may be designated by a user operation.

In the former case, it is assumed that the processing of estimating the line-of-sight direction, the face direction, and the like of the user and the processing of setting the region of interest based on the estimation result are performed outside the control unit 11B. In this case, information indicating the region of interest set externally is input to the control unit 11B as the region-of-interest designation information.

Note that it is also conceivable that the above-described estimation processing and the processing of setting the region of interest based on the estimation result are performed by the control unit 11B itself. Alternatively, it is conceivable that only the estimation processing is performed outside the control unit 11B, and the setting processing of the region of interest based on the estimation result is performed by the control unit 11B.

Furthermore, in the latter case, it is conceivable that the processing of setting the region of interest based on the user operation is performed by the control unit 11B. In this case, information of an operation performed by the user to designate the region of interest is input to the control unit 11B as the region-of-interest designation information.

Note that it is also conceivable to specify the region of interest by image analysis of the target image. For example, it is conceivable to use an artificial intelligence model on which machine learning such as deep learning is performed so as to infer the region of interest from the input image.

The control unit 11B in the present example calculates a plurality of multiplexing images used for shift multiplexing display and calculates a correction hologram for each of the multiplexing images only for the region of interest designated by the region-of-interest designation information.

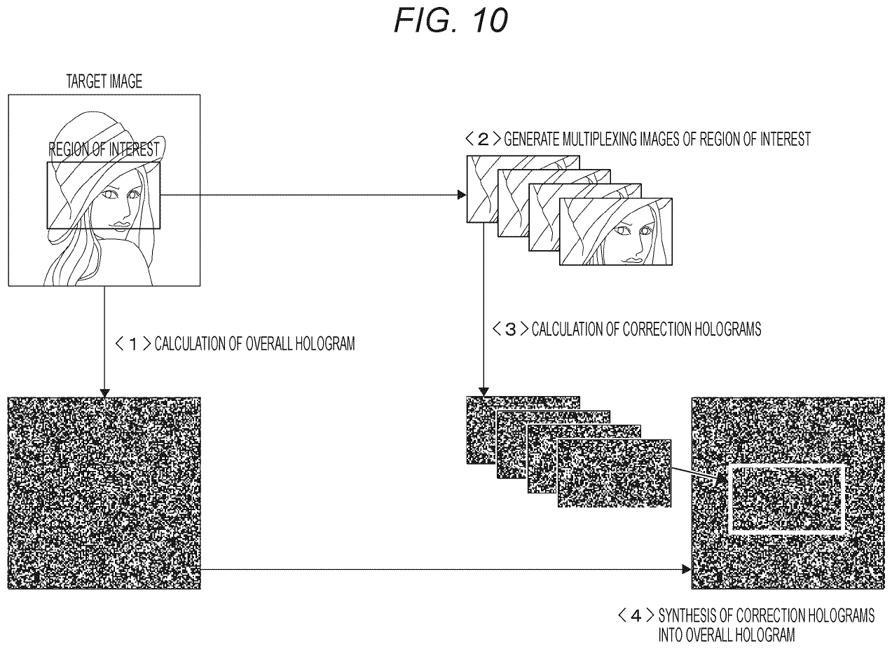

FIG. 10 is an explanatory diagram of a degradation correction method as the third embodiment.

First, as indicated by <1> in the drawing, the control unit 11B calculates an overall hologram from a target image. This processing is processing of calculating a pre-degradation hologram from the target image, similarly to the processing in step 3101 described above. In the second embodiment, a pre-degradation hologram for the entire target image is referred to as an overall hologram.

Furthermore, as indicated by <2> in the drawing, the control unit 11B generates a multiplexing image of the region of interest on the basis of the target image.

Then, as indicated by <3> in the drawing, the control unit 11B converts each multiplexing image for the region of interest into a hologram to obtain a plurality of correction holograms.

Then, the control unit 11B synthesizes the correction hologram generated in <3> with the overall hologram calculated in <1>. This synthesis with the overall hologram is performed for each correction hologram.

Thereafter, each synthetic hologram is converted into a spatial light modulation pattern, and the spatial light modulation pattern for each synthetic hologram is output to the drive unit 12 in a time division manner.

As a result, it is possible to realize degradation correction limited to the region of interest.

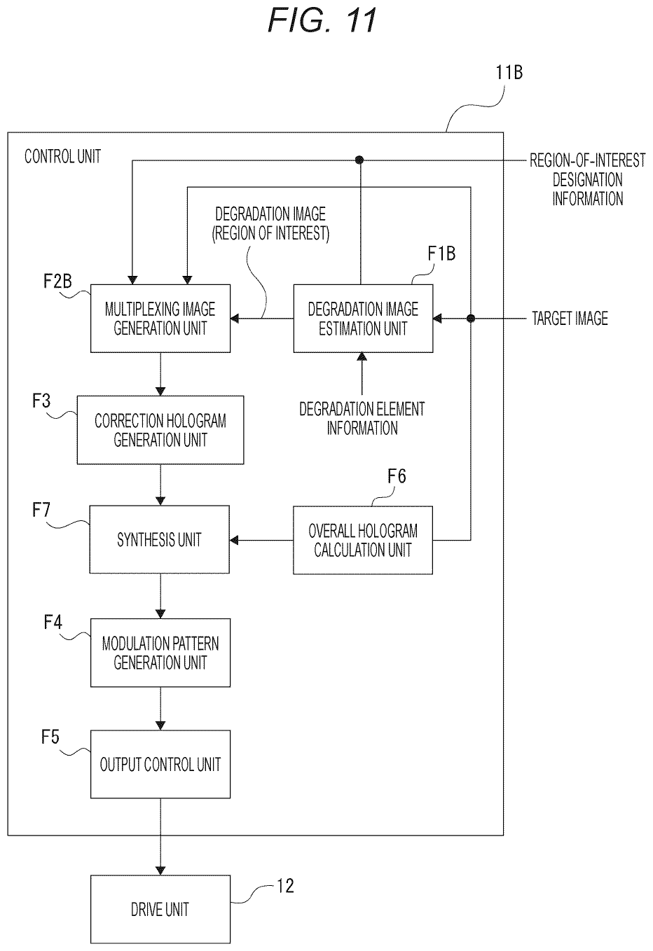

FIG. 11 is an explanatory diagram of functions of the control unit 11B.

As illustrated, the control unit 11B is different from the control unit 11 in that the control unit 11B has a function as a degradation image estimation unit F1B instead of the degradation image estimation unit F1, and a function as a multiplexing image generation unit F2B instead of the multiplexing image generation unit F2, and functions as an overall hologram calculation unit F6 and a synthesis unit F7 are added.

The degradation image estimation unit F1B generates a degradation image for the region of interest on the basis of the target image, the degradation element information, and the region-of-interest designation information.

The processing performed by the degradation image estimation unit FIB is similar to the processing performed by the degradation image estimation unit F1 except that the image region to be processed is limited to the region of interest, and thus redundant description is avoided.

The multiplexing image generation unit F2B generates the multiplexing image of the region of interest by calculation on the basis of the degradation image, the target image, and the region-of-interest designation information for the region of interest obtained by the degradation image estimation unit FIB.

Specifically, the multiplexing image generation unit F2B generates the multiplexing image of the region of interest on the basis of the difference between the image of the region of interest in the target image and the degradation image of the region of interest obtained by the degradation image estimation unit FIB. This processing is similar to the processing of the multiplexing image generation unit F2 except that the image region to be processed is limited to the region of interest, and thus overlapping description is avoided.

The correction hologram generation unit F3 in this case converts each multiplexing image of the region of interest generated by the multiplexing image generation unit F2B into a hologram to obtain each correction hologram for the region of interest (see <3> in FIG. 10).

The overall hologram calculation unit F6 performs calculation to convert the target image into a hologram to obtain an overall hologram.

The synthesis unit F7 synthesizes the correction hologram for the region of interest obtained by the correction hologram generation unit F3 with the overall hologram obtained by the overall hologram calculation unit F6. As described above, the synthesis with the overall hologram is performed for each correction hologram. That is, in the present example, since four correction holograms are generated, four holograms having different synthesized correction holograms can be obtained as a synthetic hologram.

The modulation pattern generation unit F4 in this case converts each synthetic hologram obtained by the synthesis unit F7 into a spatial light modulation pattern.

Then, the output control unit F5 in this case outputs the spatial light modulation pattern for each synthetic hologram obtained by the modulation pattern generation unit F4 to the drive unit 12 in a time division manner.

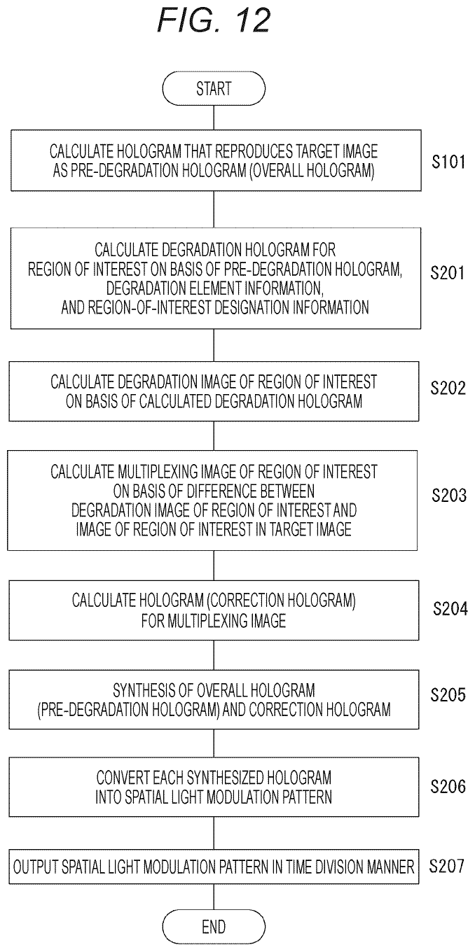

FIG. 12 is a flowchart illustrating an example of a specific processing procedure executed by the control unit 11B to implement the degradation correction method as the third embodiment described above.

Note that, also in the processing illustrated in FIG. 12, similarly to the processing illustrated in FIG. 6, in a case of display of a moving image, the illustrated processing may be executed for each frame image using a frame image constituting the moving image as a target image, and in a case of display of a still image, it is sufficient that the illustrated processing is repeatedly executed for a common target image.

First, in step S101, the control unit 11B calculates a hologram that reproduces the target image as a pre-degradation hologram (overall hologram). This processing corresponds to the processing described as the overall hologram calculation unit F6 described above.

In response to execution of the processing of step S101, the control unit 11B advances the processing to step S201.

In step S201, the control unit 11B calculates a degradation hologram for the region of interest on the basis of the pre-degradation hologram, the degradation element information, and the region-of-interest designation information of the region of interest. That is, the image of the region of interest in the target image is converted into a hologram on the basis of the region-of-interest designation information to obtain a pre-degradation hologram of the region of interest, and various types of degradation imparting processing using the degradation element information is performed on the pre-degradation hologram of the region of interest to obtain a degradation hologram of the region of interest.

In step S202 following step S201, the control unit 11B calculates a degradation image of the region of interest on the basis of the calculated degradation hologram.

Then, in step S203 subsequent to step S202, the control unit 11B calculates a multiplexing image of the region of interest on the basis of a difference between the degradation image of the region of interest and the image of the region of interest in the target image, and further calculates a hologram (correction hologram) of the multiplexing image in subsequent step S204. The processing in steps S203 and S204 is processing corresponding to the above-described multiplexing image generation unit F2B and processing corresponding to the correction hologram generation unit F3, respectively.

In step S205 subsequent to step S204, the control unit 11B performs synthesis processing of the overall hologram (pre-degradation hologram) and the correction hologram. That is, it is a process of synthesizing the overall hologram as the pre-degradation hologram calculated in step S101 and each correction hologram calculated in step S204. As described above, the synthesis with the overall hologram is performed for each correction hologram.

In step S206 subsequent to step S205, the control unit 11B converts each synthetic hologram into a spatial light modulation pattern, and further outputs the spatial light modulation pattern in a time division manner in subsequent step S207.

The control unit 11B terminates the series of processes illustrated in FIG. 12 in response to the execution of the process of step S207.

Note that the method of performing the degradation correction by narrowing down to a part of the image region as in the third embodiment can also be applied to a case where an amplitude modulator is used as the spatial light modulator as in the second embodiment.

### 4. Modifications

Although various embodiments according to the present technology have been described above, the present technology is not limited to the specific examples described above, and configurations as various modifications can be adopted.

For example, in the above description, it is assumed that calculation assuming a reproduction surface by a two-dimensional plane is performed for calculation of a correction hologram, but calculation of a correction hologram assuming a reproduction surface having irregularities as the reproduction surface can also be performed.

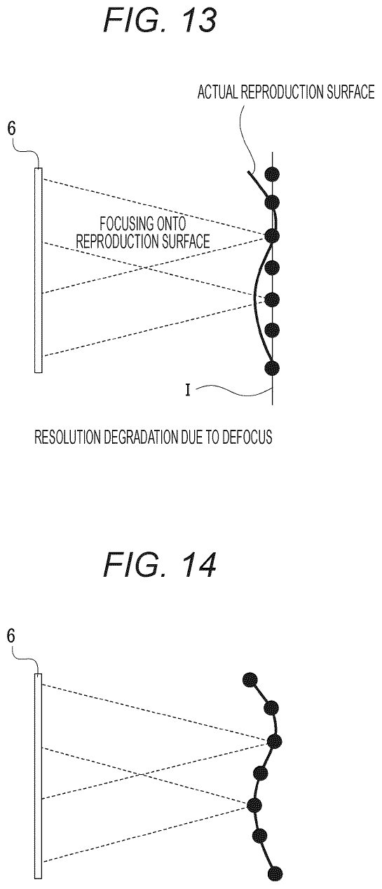

For example, as illustrated in FIG. 13, the actual reproduction surface may not be a two-dimensional plane indicated by “I” in the drawing, but may be a surface having relatively large irregularities. At this time, in particular, assuming that a light diffusing element such as a microlens array, a holographic optical element (HOE), or a diffractive optical element (DOE) is arranged on the reproduction surface in order to improve the viewing angle characteristic or the like, when hologram calculation assuming a two-dimensional plane as the reproduction surface is performed, the image forming position of each light beam of the reproduced image does not coincide with the position of the diffusing element, that is, defocusing occurs with respect to the diffusing element, and the diffusion of light by the diffusing element is not appropriately performed, and the viewing angle characteristic is not improved.

Therefore, as illustrated in FIG. 14, the correction hologram is calculated assuming a surface having irregularities as the reproduction surface. Specifically, three-dimensional information indicating the uneven shape of the reproduction surface is actually measured in advance, and the actually measured three-dimensional information is used as three-dimensional information of the assumed reproduction surface in calculation of the correction hologram.

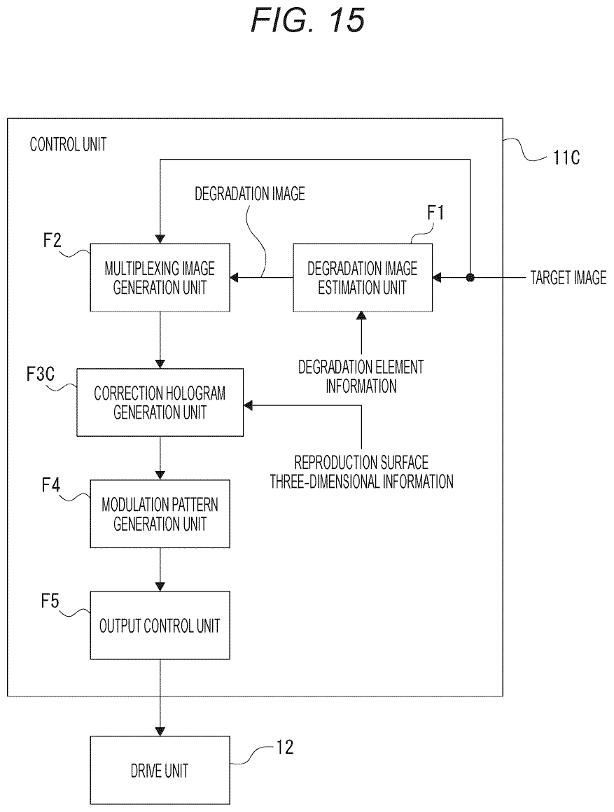

FIG. 15 is a diagram for describing a holographic projector apparatus 1C that calculates a correction hologram using the three-dimensional information of the reproduction surface as described above. Specifically, it is a functional explanatory diagram of a control unit 11C included in the holographic projector apparatus 1C. Note that, in the holographic projector apparatus 1C, the configuration other than the control unit 11C is similar to that of the holographic projector apparatus 1 described in the first embodiment, for example, and redundant description is avoided.

The control unit 11C is different from the control unit 11 in that a correction hologram generation unit F3C is included instead of the correction hologram generation unit F3.

Measured three-dimensional information of the reproduction surface is input to the correction hologram generation unit F3C as reproduction surface three-dimensional information. Here, it is conceivable that the reproduction surface three-dimensional information is stored in a memory that can be read by the control unit 11C, similarly to the degradation element information.

The correction hologram generation unit F3C uses the coordinate information indicated by the reproduction surface three-dimensional information as the coordinate information of the reproduction surface assumed in the calculation of the correction hologram.

As a result, it is possible to calculate an appropriate correction hologram for resolution degradation correction corresponding to a case where the actual reproduction surface is a surface having irregularities. In particular, in a case where the above-described configuration in which the diffusion element is disposed on the reproduction surface is adopted, the condensing position of each light beam of the reproduced image can be matched with the position of the diffusion element, and the viewing angle characteristic can be improved.

Here, in the above description, an example of displaying a 2D image has been described, but the present technology can also be suitably applied to a case of displaying a 3D image.

Furthermore, the present technology can also be suitably applied to a case of displaying a color image.

For example, it is conceivable to provide a spatial light modulator for each color of red (R), green (G), and blue (B), generate a correction hologram based on a target image and a degradation image for each color, and perform shift multiplexing display using the generated correction hologram.

Alternatively, it is also conceivable that the spatial light modulation region for each color is defined for the single-plate spatial light modulator, the spatial light modulation region for each color is regarded as the spatial light modulator for each color, and generation of a correction hologram based on a target image and a degradation image for each color and shift multiplexing display using the generated correction hologram are similarly performed.

If the above configuration is adopted as the configuration for displaying the color image, the reproduced images of the respective colors can be simultaneously displayed without time division, so that color breakup can be suppressed.

Note that, in a case where color breakup can be ignored or the like, it is also conceivable to adopt a configuration in which shift multiplexing display using a correction hologram generated for each color is performed in a time division manner.

Further, in the above description, the case of performing the resolution degradation correction by the shift multiplexing display has been exemplified, but for example, it is also conceivable to generate one correction hologram for canceling the difference between the target image and the degradation image and form the correction hologram by the spatial light modulation unit so that the resolution degradation correction is realized. In this case, as the correction hologram, for example, it is conceivable to calculate a blur function for each pixel of the degradation image, generate an image for correction by multiplying the pixel value by an inverse function of the blur function for each pixel of the target image, and generate the image for correction as a hologram for reproducing the image for correction.

Furthermore, in the above description, an example of using a semiconductor laser as the light source 2 has been described, but it is also conceivable to use a light emitting element other than a semiconductor laser, such as a light emitting diode (LED), for example, as the light source 2.

In addition, in the above description, an example of using a reflective liquid crystal panel as the spatial light modulator for hologram formation has been described, but it is also conceivable to use a reflective spatial light modulator other than the liquid crystal panel.

For example, in a case where the phase modulator is used as in the first embodiment, it is conceivable to use a micro electro mechanical systems (MEMS) mirror, specifically, a MEMS mirror configured to be able to adjust the height of the mirror surface for each pixel.

In addition, in a case where an amplitude modulator is used as in the second embodiment, it is conceivable to use a digital micro mirror device (DMD).

In addition, it is also possible to use a transmissive spatial light modulator instead of a reflective spatial light modulator.

### 5. Summary of Embodiments

As described above, a holographic projector apparatus (1, 1A, 1B, or 1C) as an embodiment includes a light source (2), a spatial light modulation unit (6 or 6A) that performs spatial light modulation to light emitted from the light source, a projection unit (relay lens 7 or 8 or projection lens 10) that projects a reproduced image generated by the spatial light modulation unit, and a control unit (11, 11A, 11B, or 11C) that calculates a correction hologram for correcting degradation of the reproduced image on the basis of a target image and degradation element information that is information indicating at least a resolution degradation element of the reproduced image generated on a projection path from the light source to the projection unit, and performs control so that the spatial light modulation unit is driven by a spatial light modulation pattern based on the calculated correction hologram.

According to the above configuration, it is possible to perform resolution degradation correction in consideration of the resolution degradation element actually occurring in the projection path, and it is possible to realize appropriate resolution degradation correction. In addition, by performing resolution degradation correction, a low-resolution spatial light modulator can be used.

Therefore, in the holographic projector apparatus, it is possible to suppress the resolution degradation while reducing the price.

In addition, the holographic projector apparatus according to the embodiment includes an optical filter (9) that performs optical filter processing on a reproduced image, and the degradation element information includes information on a resolution degradation element by the optical filter.

As a result, the resolution degradation can be corrected corresponding to the case where the resolution degradation element is generated by the optical filter.

Furthermore, in the holographic projector apparatus as an embodiment, the optical filter is an optical filter that removes noise light.

The resolution of the reproduced image is degraded depending on the optical filter that removes the noise light.

Therefore, it is preferable to perform the resolution degradation correction in consideration of the resolution degradation element by the optical filter.

Furthermore, as an embodiment, in the holographic projector apparatus, the spatial light modulation unit performs spatial light modulation by the liquid crystal panel, and the degradation element information includes information on the degradation element of the reproduced image generated in the liquid crystal panel.

Consequently, the degradation correction of the reproduced image can be performed corresponding to the case that the degradation element of the reproduced image is generated in the liquid crystal panel used for the spatial light modulation.

In addition, in the holographic projector apparatus according to the embodiment, the degradation element information includes information on the degradation element of the reproduced image due to the disclination of the liquid crystal panel.

As a result, degradation correction of the reproduced image due to the disclination is realized, and it is possible to eliminate the need to use a liquid crystal panel having a large pixel pitch for a measure against the disclination or to use a liquid crystal panel having four or more times the number of pixels of the reproduced image.

Therefore, downsizing and cost reduction of the holographic projector apparatus can be achieved.

Further, in the holographic projector apparatus as the embodiment, the degradation element information includes information indicating the degradation element caused by the optical aberration generated in the reproduced image.

As a result, it is possible to calculate, as a correction hologram, a hologram capable of performing not only correction of resolution degradation but also correction of degradation caused by optical aberration occurring in a reproduced image such as lens distortion in a projection lens system, for example.

Therefore, the image quality of the display image can be improved.

Furthermore, as an embodiment, in the holographic projector apparatus, the control unit controls the spatial light modulation unit so that degradation is corrected by a method of performing shift multiplexing display on a plurality of reproduced images.

By performing shift multiplexing display, it is possible to realize high-resolution image display using a reproduced image with low resolution. That is, resolution degradation correction based on a so-called super-resolution technique can be realized.

Furthermore, in the holographic projector apparatus as an embodiment, the control unit controls the spatial light modulation unit so that a plurality of correction holograms for shift multiplexing display are formed in a time division manner.

By forming a plurality of correction holograms for shift multiplexing display in a time division manner as described above, it is possible to realize a shift of a reproduced image for shift multiplexing display by the correction holograms.

Since the shift of the reproduced image is realized by the time-division formation of the correction hologram, it is not necessary to provide a shift device for shifting the position of the reproduced image on the reproduction surface in order to realize the shift multiplexing display. Therefore, it is possible to reduce the number of components in realizing the resolution degradation correction, and it is possible to reduce the size and weight of the holographic projector apparatus and to reduce the price thereof.

Furthermore, in the holographic projector apparatus as the embodiment, the control unit calculates a hologram that reproduces a target image as a pre-degradation hologram, calculates a degradation hologram on the basis of the pre-degradation hologram and the degradation element information, calculates a reproduced image by the degradation hologram as a degradation image, calculates a plurality of multiplexing images to be used for shift multiplexing display on the basis of a difference between the calculated degradation image and the target image, calculates, for each calculated multiplexing image, a hologram for obtaining the multiplexing image as a reproduced image as a correction hologram, and controls the spatial light modulation unit such that a correction hologram for each calculated multiplexing image is formed in a time division manner.

By forming the correction holograms for each multiplexing image in a time division manner as described above, the correction holograms realize the shift of the reproduced image for the shift multiplexing display.

Therefore, it is not necessary to provide a shift device for shifting the position of the reproduced image on the reproduction surface in realizing the shift multiplexing display, and the number of parts in realizing the resolution degradation correction can be reduced, and the holographic projector apparatus can be reduced in size and weight and in price.

Furthermore, in a holographic projector apparatus (1, 1B, or 1C) as an embodiment, the spatial light modulation unit performs spatial light phase modulation as spatial light modulation.

By generating the reproduced image by spatial light modulation, it is possible to improve utilization efficiency of light in image display, increase contrast of a display image, and reduce power consumption of a light source.

In addition, in the holographic projector apparatus (1B) as the embodiment, the control unit (11B) controls the spatial light modulation unit such that the correction hologram is formed only in a designated part of the image region in the reproduced image.

As a result, for example, it is possible to perform the calculation processing for the resolution degradation correction only to a part of the image region that particularly needs to be corrected, such as an image region that the user pays attention to.

Therefore, it is possible to reduce a calculation processing load required for resolution degradation correction.

Furthermore, in the holographic projector apparatus as the embodiment, the control unit (11C) calculates a hologram assuming a reproduction surface having irregularities as the calculation of the correction hologram.

As a result, it is possible to calculate an appropriate correction hologram for resolution degradation correction corresponding to a case where the actual reproduction surface is a surface having irregularities.

Furthermore, a control method as an embodiment is a control method in a holographic projector apparatus including a light source, a spatial light modulation unit that performs spatial light modulation to light emitted from the light source, and a projection unit that projects a reproduced image generated by the spatial light modulation unit, the control method including: calculating a correction hologram for correcting degradation of the reproduced image on the basis of a target image and degradation element information that is information indicating at least a resolution degradation element of the reproduced image generated on a projection path from the light source to the projection unit; and performing control so that the spatial light modulation unit is driven by a spatial light modulation pattern based on the calculated correction hologram.

Also by such a control method, it is possible to obtain the same operations and effects as those of the holographic projector apparatus according to the above-described embodiments.

Note that the effects described in the present specification are merely examples and are not limited, and other effects may be provided.

### 6. Present Technology

The present technology can also adopt the following configurations.

(1)

A holographic projector apparatus including:
a light source;
a spatial light modulation unit that performs spatial light modulation on light emitted from the light source;
a projection unit that projects a reproduced image generated by the spatial light modulation unit; and
a control unit that calculates a correction hologram for correcting degradation of the reproduced image on the basis of a target image and degradation element information that is information indicating at least a resolution degradation element of the reproduced image generated on a projection path from the light source to the projection unit, and performs control such that the spatial light modulation unit is driven by a spatial light modulation pattern based on the correction hologram calculated.
   (2)

The holographic projector apparatus according to (1), further including
an optical filter that performs optical filter processing on the reproduced image, in which
the degradation element information includes information on a resolution degradation element by the optical filter.
   (3)

The holographic projector apparatus according to (2), in which
the optical filter is an optical filter that removes noise light.
   (4)

The holographic projector apparatus according to any one of (1) to (3), in which
the spatial light modulation unit performs the spatial light modulation by a liquid crystal panel, and
the degradation element information includes information on a degradation element of a reproduced image generated in the liquid crystal panel.
   (5)

The holographic projector apparatus according to (4), in which
the degradation element information includes information on a degradation element of a reproduced image due to disclination of the liquid crystal panel.
   (6)

The holographic projector apparatus according to any one of (1) to (5), in which
the degradation element information includes information indicating a degradation element caused by optical aberration occurring in the reproduced image.
   (7)

The holographic projector apparatus according to (1), in which
the control unit is configured to
control the spatial light modulation unit such that the degradation is corrected by a method of performing shift multiplexing display on a plurality of reproduced images.
   (8)

The holographic projector apparatus according to (7), in which
the control unit is configured to
control the spatial light modulation unit such that a plurality of the correction hologram for the shift multiplexing display is formed in a time division manner.
   (9)

The holographic projector apparatus according to (8), in which
the control unit is configured to:
calculate a hologram that reproduces the target image as a pre-degradation hologram;
calculate a degradation hologram on the basis of the pre-degradation hologram and the degradation element information;
calculate a reproduced image by the degradation hologram as a degradation image;
calculate a plurality of multiplexing images to be used for the shift multiplexing display on the basis of a difference between the degradation image calculated and the target image;
calculate, as the correction hologram, a hologram for obtaining the multiplexing image as a reproduced image for each multiplexing image calculated; and
control the spatial light modulation unit such that the correction hologram for each multiplexing image calculated is formed in a time division manner.
   (10)

The holographic projector apparatus according to any one of (1) to (9), in which
the spatial light modulation unit performs spatial light phase modulation as the spatial light modulation.
   (11)

The holographic projector apparatus according to any one of (1) to (10), in which
the control unit is configured to
control the spatial light modulation unit such that the correction hologram is formed only in a designated part of an image region in the reproduced image.
   (12)

The holographic projector apparatus according to any one of (1) to (11), in which
the control unit is configured to
calculate a hologram assuming a reproduction surface having irregularities as calculation of the correction hologram.
   (13)

A control method in a holographic projector apparatus including:
a light source; a spatial light modulation unit that performs spatial light modulation on light emitted from the light source; a projection unit that projects a reproduced image generated by the spatial light modulation unit,
the control method including calculating a correction hologram for correcting degradation of the reproduced image on the basis of a target image and degradation element information that is information indicating at least a resolution degradation element of the reproduced image generated on a projection path from the light source to the projection unit, and performs control such that the spatial light modulation unit is driven by a spatial light modulation pattern based on the correction hologram calculated.

### REFERENCE SIGNS LIST

1, 1A, 1B, 1C Holographic projector apparatus
2 Light source
3 Beam expander
4 Collimator lens
5 Beam splitter
6, 6A Spatial light modulation unit
7, 8 Relay lens
9 Optical filter
10 Projection lens
11A, 11B, 11C Control unit
12 Drive unit
S Screen
F1, F1A Degradation image estimation unit
F2, F2B Multiplexing image generation unit
F3, F3C Correction hologram generation unit
F4 Modulation pattern generation unit
F5 Outout control unit
F6 Overall hologram calculation unit
F7 Synthesis unit

1. A holographic projector apparatus comprising:
a light source;
a spatial light modulation unit that performs spatial light modulation on light emitted from the light source;
a projection unit that projects a reproduced image generated by the spatial light modulation unit; and
a control unit that calculates a correction hologram for correcting degradation of the reproduced image on a basis of a target image and degradation element information that is information indicating at least a resolution degradation element of the reproduced image generated on a projection path from the light source to the projection unit, and performs control such that the spatial light modulation unit is driven by a spatial light modulation pattern based on the correction hologram calculated.

2. The holographic projector apparatus according to claim 1, further comprising
an optical filter that performs optical filter processing on the reproduced image, wherein
the degradation element information includes information on a resolution degradation element by the optical filter.

3. The holographic projector apparatus according to claim 2, wherein
the optical filter is an optical filter that removes noise light.

4. The holographic projector apparatus according to claim 1, wherein
the spatial light modulation unit performs the spatial light modulation by a liquid crystal panel, and
the degradation element information includes information on a degradation element of a reproduced image generated in the liquid crystal panel.

5. The holographic projector apparatus according to claim 4, wherein
the degradation element information includes information on a degradation element of a reproduced image due to disclination of the liquid crystal panel.

6. The holographic projector apparatus according to claim 1, wherein
the degradation element information includes information indicating a degradation element caused by optical aberration occurring in the reproduced image.

7. The holographic projector apparatus according to claim 1, wherein
the control unit is configured to
control the spatial light modulation unit such that the degradation is corrected by a method of performing shift multiplexing display on a plurality of reproduced images.

8. The holographic projector apparatus according to claim 7, wherein
the control unit is configured to
control the spatial light modulation unit such that a plurality of the correction hologram for the shift multiplexing display is formed in a time division manner.

9. The holographic projector apparatus according to claim 8, wherein
the control unit is configured to:
calculate a hologram that reproduces the target image as a pre-degradation hologram;
calculate a degradation hologram on a basis of the pre-degradation hologram and the degradation element information;
calculate a reproduced image by the degradation hologram as a degradation image;
calculate a plurality of multiplexing images to be used for the shift multiplexing display on a basis of a difference between the degradation image calculated and the target image;
calculate, as the correction hologram, a hologram for obtaining the multiplexing image as a reproduced image for each multiplexing image calculated; and
control the spatial light modulation unit such that the correction hologram for each multiplexing image calculated is formed in a time division manner.

10. The holographic projector apparatus according to claim 1, wherein
the spatial light modulation unit performs spatial light phase modulation as the spatial light modulation.

11. The holographic projector apparatus according to claim 1, wherein
the control unit is configured to
control the spatial light modulation unit such that the correction hologram is formed only in a designated part of an image region in the reproduced image.

12. The holographic projector apparatus according to claim 1, wherein
the control unit is configured to
calculate a hologram assuming a reproduction surface having irregularities as calculation of the correction hologram.

13. A control method in a holographic projector apparatus including:
a light source; a spatial light modulation unit that performs spatial light modulation on light emitted from the light source; a projection unit that projects a reproduced image generated by the spatial light modulation unit,
the control method including calculating a correction hologram for correcting degradation of the reproduced image on a basis of a target image and degradation element information that is information indicating at least a resolution degradation element of the reproduced image generated on a projection path from the light source to the projection unit, and performs control such that the spatial light modulation unit is driven by a spatial light modulation pattern based on the correction hologram calculated.
